(19) United States
(12) Patent Application Publication
(10) Pub. No.: US 2026/0233668 A1
(43) Pub. Date: Aug. 13, 2026

(54) METHOD AND SYSTEM FOR OPERATING TURN SIGNAL BASED ON ROAD INFORMATION AHEAD

(71) Applicant: HL Klemove Corp., Incheon (KR)

(72) Inventor: Taehan KIM, Incheon (KR)

(73) Assignee: HL Klemove Corp., Incheon (KR)

(21) Appl. No.: 19/275,295

(22) Filed: Jul. 21, 2025

(30) Foreign Application Priority Data
Feb. 12, 2025 (KR) 10-2025-0017937

(51) Int. Cl. B60Q 1/34; B60W 30/18

(52) U.S. Cl. CPC B60Q 1/346; B60W 30/18154; B60W 30/18159; B60W 2420/403; B60W 2420/408; B60W 2520/10; B60W 2540/18

(57) ABSTRACT

A method and a system for operating a turn signal based on road information ahead are provided, and the method for operating a turn signal based on road information ahead according to an embodiment of the present disclosure comprises: determining road information ahead based on navigation information; determining whether operation of a turn signal is required based on the road information ahead and a driving path of an ego vehicle according to the navigation information; and operating the turn signal of the ego vehicle based on whether the operation of the turn signal is required.

### CROSS-REFERENCE TO RELATED APPLICATION

This application claims the benefit of and priority to Korean Patent Application No. 10-2025-0017937 filed on Feb. 12, 2025, the entire disclosures of which are incorporated herein by reference.

### TECHNICAL FIELD

The present disclosure relates to a method and system for operating a turn signal based on road information ahead. More specifically, the present disclosure relates to a method and system for operating a turn signal based on road information ahead, capable of appropriately operating the turn signal based on the type of road ahead and the predicted driving path of the vehicle.

### BACKGROUND

In a vehicle, an Autonomous Driving System provides the function of recognizing the surrounding environment, determining the driving situation, and controlling the vehicle to drive to a given destination by itself, without driver intervention.

In providing functions according to such an autonomous driving system, when the vehicle is driving on urban roads, there are many situations where turn signal operation according to the driving scenario is required, in addition to lane change scenarios.

Meanwhile, according to the prior art, there was a problem in that a proper method for controlling the turn signal to operate appropriately in vehicle driving scenarios requiring turn signal operation was not adequately established.

Therefore, there is a need for a method and system for operating a turn signal capable of operating the turn signal according to the turning or driving direction in driving situations such as making left or right turns at intersections, entering or exiting roundabouts, etc.

### SUMMARY

The present disclosure is to solve the problems of the prior art described above, and an object of the present disclosure is to provide a method and system for operating a turn signal capable of appropriately operating the turn signal in advance based on the driving path of the vehicle according to road information ahead and navigation information.

Further, an object of the present disclosure is to provide a method and system for operating a turn signal capable of accurately determining the operating direction of the turn signal light using information regarding the road type from a navigation map or high-definition map and turn angle information according to the predicted driving path of the ego vehicle.

However, the technical problems to be achieved by the embodiments of the present disclosure are not limited to the technical problems described above, and other technical problems may exist.

As a technical means for achieving the above technical problem, a method for operating a turn signal based on road information ahead according to an embodiment of the present disclosure comprises: determining road information ahead based on navigation information; determining whether operation of a turn signal is required based on the road information ahead and a driving path of an ego vehicle according to the navigation information; and operating the turn signal of the ego vehicle based on whether the operation of the turn signal is required.

Further, if the road information ahead indicates an intersection in the determining of the road information, the determining of whether the operation of the turn signal is required may further comprise: determining a size of a turn angle of the ego vehicle according to a predicted driving path at the intersection based on the driving path of the ego vehicle according to the navigation information.

Further, the size of the turn angle of the ego vehicle may be obtained by summing angles of tangent lines at respective positions of a curve comprising a plurality of points along a navigation route.

Further, the determining of whether the operation of the turn signal is required may further comprise: determining a turn start distance from a current position of the ego vehicle to a position where the ego vehicle starts turning.

Further, the method may further comprise: determining that operation of a left turn signal is required by determining that the ego vehicle will make a left turn at the intersection, if the turn angle of the ego vehicle exceeds a predetermined angle in a counter-clockwise direction and the turn start distance is less than a predetermined distance.

Further, the method may further comprise: determining that operation of a right turn signal is required by determining that the ego vehicle will make a right turn at the intersection, if the turn angle of the ego vehicle exceeds the predetermined angle in a clockwise direction and the turn start distance is less than the predetermined distance.

Further, if the road information ahead indicates a roundabout in the determining of the road information, the determining of whether the operation of the turn signal is required may comprise: determining that operation of a left turn signal is required at a predetermined distance before entering the roundabout.

Further, the method may further comprise: after the ego vehicle enters the roundabout, controlling the left turn signal to an OFF state.

Further, the method may further comprise: while the ego vehicle is driving in the roundabout, determining that operation of a right turn signal is required if it is determined that the ego vehicle will drive towards an exit lane of the roundabout, based on the road information ahead and the driving path of the ego vehicle according to the navigation information.

Further, if the road information ahead indicates a highway entrance lane or a highway exit lane in the determining of the road information, it may be determined that operation of the turn signal is required in a direction of the highway entrance lane or the highway exit lane, based on the driving path of the ego vehicle according to the navigation information.

A system for operating a turn signal based on road information ahead according to embodiments of the present disclosure comprises: a navigation device configured to provide road information ahead and a driving path of an ego vehicle; a controller configured to control operation of a turn signal of the ego vehicle based on information provided by the navigation device; and a turn signal apparatus configured to operate the turn signal of the ego vehicle, wherein the controller is configured to: determine whether operation of the turn signal is required based on the road information ahead and the driving path of the ego vehicle according to the navigation information; and control the turn signal apparatus to operate the turn signal based on whether the operation of the turn signal is required.

Further, if the road information ahead indicates an intersection, the controller may be configured to: determine a size of a turn angle of the ego vehicle according to a predicted driving path at the intersection based on the driving path of the ego vehicle according to the navigation information; and determine a turn start distance from a current position of the ego vehicle to a position where the ego vehicle starts turning.

Further, the controller may be configured to control the turn signal apparatus to operate a left turn signal by determining that the ego vehicle will make a left turn at the intersection, if the turn angle of the ego vehicle exceeds a predetermined angle in a counter-clockwise direction and the turn start distance is less than a predetermined distance.

Further, the controller may be configured to control the turn signal apparatus to operate a right turn signal by determining that the ego vehicle will make a right turn at the intersection, if the turn angle of the ego vehicle exceeds the predetermined angle in a clockwise direction and the turn start distance is less than the predetermined distance.

Further, if the road information ahead indicates a roundabout, the controller may be configured to control the turn signal apparatus to operate a left turn signal by determining that operation of the left turn signal is required at a predetermined distance before entering the roundabout.

Further, the controller may be configured to control the turn signal apparatus such that the left turn signal is in an OFF state after the ego vehicle enters the roundabout.

Further, the controller may be configured to control the turn signal apparatus to operate a right turn signal if it is determined that the ego vehicle will drive towards an exit lane of the roundabout, based on the road information ahead and the driving path of the ego vehicle according to the navigation information while the ego vehicle is driving in the roundabout.

Further, if the road information ahead indicates a highway entrance lane or a highway exit lane, the controller may be configured to control the turn signal apparatus to operate the left turn signal or the right turn signal if it is determined that the ego vehicle will drive in a direction of the highway entrance lane or the exit lane, based on the driving path of the ego vehicle according to the navigation information.

Further, the system may further comprise: a first sensor configured to detect surroundings of the ego vehicle; and a second sensor configured to detect body information of the ego vehicle, wherein the first sensor comprises at least one of a front camera, a front radar, or a corner radar, and the second sensor comprises at least one of a steering angle sensor or a vehicle speed sensor.

Meanwhile, in a non-transitory computer-readable recording medium that records a program for executing a method for operating a turn signal based on road information ahead according to an embodiment of the present disclosure, the method comprises: determining road information ahead based on navigation information; determining whether operation of a turn signal is required based on the road information ahead and a driving path of an ego vehicle according to the navigation information; and operating the turn signal of the ego vehicle based on whether the operation of the turn signal is required.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, by utilizing road information ahead and the driving path of the ego vehicle, it is possible to provide a method and system for operating a turn signal based on road information ahead that can operate the turn signal in the appropriate direction at the appropriate time point when turn signal operation is required.

Further, according to the present disclosure, it is possible to provide a method and system for operating a turn signal based on road information ahead that can control optimal turn signal operation in various road driving scenarios according to road types, during autonomous driving in urban roads.

However, the effects obtainable from the present disclosure are not limited to the effects described above, and other effects may exist.

### BRIEF DESCRIPTION OF THE DRAWINGS

FIG. 1 is a control flowchart showing a method for operating a turn signal based on road information ahead according to an embodiment of the present disclosure.

FIG. 2 is a control flowchart showing in more detail the step of determining whether turn signal operation is required and the turn signal operating step if the road ahead is an intersection, in the method for operating the turn signal based on road information ahead according to the embodiment of the present disclosure.

FIG. 3 is a control flowchart showing in more detail the step of determining whether turn signal operation is required and the turn signal operating step if the road ahead is a roundabout or other cases, in the method for operating the turn signal based on road information ahead according to the embodiment of the present disclosure.

FIG. 4 is a diagram for explaining a method for determining whether turn signal operation is required if the road ahead is an intersection and the ego vehicle makes a left turn along the driving path, in the method for operating the turn signal based on road information ahead according to the embodiment of the present disclosure.

FIG. 5 is a diagram for explaining a method for determining whether turn signal operation is required if the road ahead is an intersection and the ego vehicle makes a right turn along the driving path, in the method for operating the turn signal based on road information ahead according to the embodiment of the present disclosure.

FIG. 6 is a diagram for explaining a method for determining whether turn signal operation is required if the road ahead is a roundabout, in the method for operating the turn signal based on road information ahead according to the embodiment of the present disclosure.

FIG. 7 is a control configuration diagram schematically showing the configuration of a system for operating a turn signal based on road information ahead according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for operating a turn signal based on road information ahead, which appropriately controls turn signal operation based on the requirement of turn signal operation according to the driving path of the vehicle based on the road information ahead.

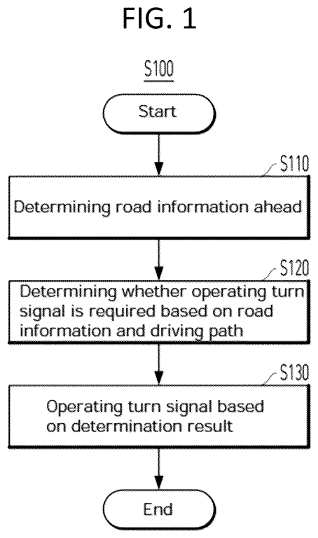

FIG. 1 is a control flowchart showing a method for operating a turn signal based on road information ahead according to an embodiment of the present disclosure.

Referring to FIG. 1, the method for operating a turn signal based on road information ahead S100 according to an embodiment of the present disclosure may comprise determining road information ahead based on navigation information S110.

Specifically, based on navigation information, road information regarding whether the road located in the front area where the ego vehicle is driving is an intersection, a roundabout, an entrance lane (ramp), or an exit lane (ramp), etc., may be determined. Meanwhile, if the ego vehicle is equipped with an HD Map, road information ahead may also be obtained from the HD Map information.

After the road information ahead is determined, determining whether operation of the turn signal is required based on the determined road information ahead and the driving path of the ego vehicle S120 may be performed.

Here, the driving path of the ego vehicle may be a path based on navigation information. In relation to this, by identifying the driving path of the ego vehicle based on destination input to the navigation system, the driving path of the ego vehicle on the road ahead based on the navigation information of the road ahead may be determined.

Accordingly, in step S120, based on the driving path of the ego vehicle according to the road information ahead and the navigation information, it may be determined whether turn signal operation is necessary.

Next, based on the determination result in the step of determining whether turn signal operation is required S120, a step of operating the turn signal may be performed (S130).

According to the embodiment of the present disclosure as described above, by utilizing the road information ahead and the driving path of the ego vehicle during autonomous driving, effective driving can be enabled by operating the vehicle's turn signal appropriately in various driving scenarios such as intersections, etc.

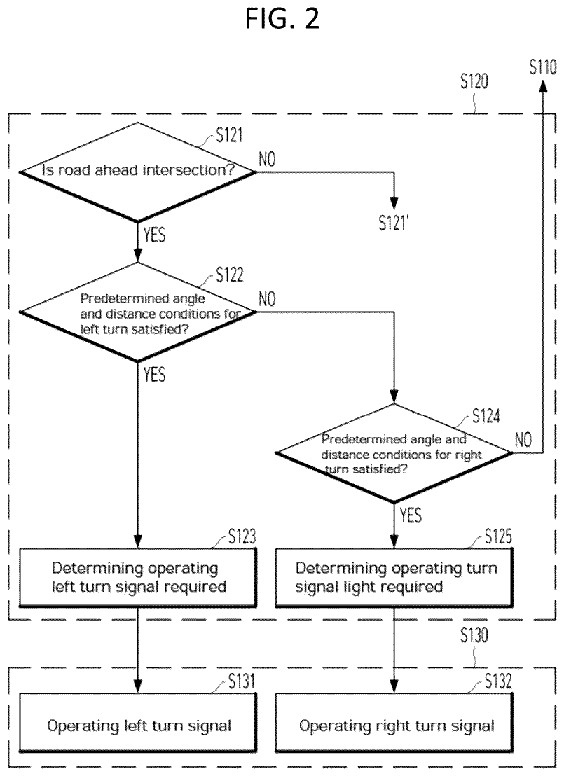

FIG. 2 is a control flowchart showing in more detail the step of determining whether turn signal operation is required and the turn signal operating step if the road ahead is an intersection, in the method for operating the turn signal based on road information ahead according to the embodiment of the present disclosure.

Referring to FIG. 2, if the road information determined in the step of determining road information ahead indicates an intersection (‘YES’ in S121), a step of determining whether conditions regarding a left turn are satisfied S122 may be performed.

Here, the intersection may be a 3-Way intersection or a 4-Way intersection, and such road information may be determined, for example, from LINKKIND information provided by navigation device. That is, if the road ahead is an intersection, the road information provided by navigation device may be indicated as LINKKIND=LINKKIND_Intersection.

Meanwhile, to determine the conditions regarding the left turn of the ego vehicle, the size of the turn angle of the ego vehicle according to the predicted driving path at the intersection based on the driving path according to the navigation information may be determined.

Further, the size of this turn angle may be determined through Lane Link Geometry. Lane Link Geometry is information that may be determined from navigation or HD map information. For example, a path for turning left or right is formed by a curve composed of a plurality of points, and by summing the angles (angle relative to the straight driving direction) of the tangent lines at each position of this curve, the turn angle (predicted turn angle according to the navigation route) of the ego vehicle can be obtained.

That is, the turn angle of the ego vehicle may be expressed as follows.

$$TurnAngle = {\sum }_{i} {a}_{i}$$

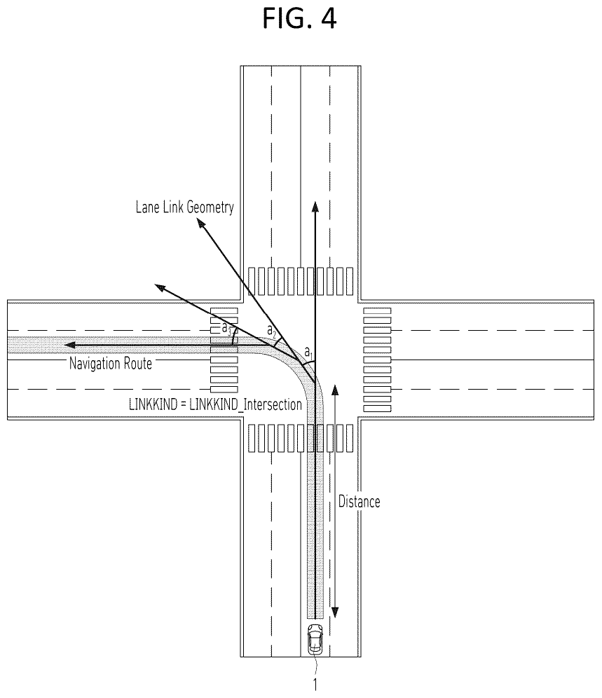

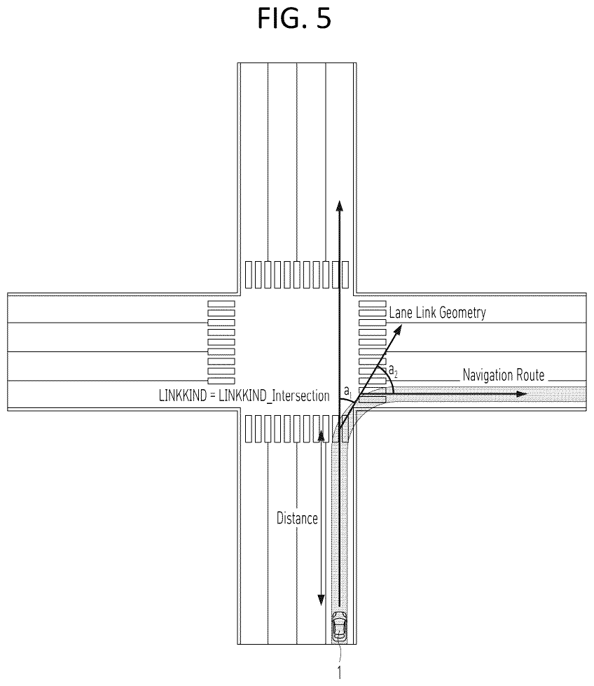

Calculation of the turn angle through summing the angles of the tangent lines of the curve using Lane Link Geometry will be described in more detail later with reference to FIG. 4 and FIG. 5.

In determining whether the turn angle of the ego vehicle exceeds a predetermined angle, a predetermined angle τ₁ in the counter-clockwise direction may be set as the minimum angle required for the ego vehicle to make a left turn.

Meanwhile, determining whether the distance condition is met may include determining the distance from the current position of the ego vehicle to the position where the ego vehicle starts turning (turn start distance). If the turn start distance is greater than or equal to a predetermined distance τ₂, it may mean there is still some distance remaining until reaching the intersection, so it may be determined that turn signal operation is not yet required.

That is, if the turn angle of the ego vehicle exceeds the predetermined angle τ₁ in the counter-clockwise direction and the turn start distance is less than the predetermined distance τ₂ (‘YES’ in S122), it is determined that the ego vehicle will make a left turn at the intersection, and thus operation of the left turn signal is required (S123). Accordingly, in the turn signal operating step S130, the turn signal may be operated such that the left turn signal light is on (S131).

Meanwhile, if the conditions regarding the left turn of the ego vehicle are not met (‘NO’ in S122), a step of determining whether conditions regarding a right turn of the ego vehicle are met S124 may be performed.

If the ego vehicle makes a right turn according to the navigation route, the turn angle (predicted turn angle according to the navigation route) of the ego vehicle would be in the clockwise direction, which is opposite to the left turn. It may be determined whether this turn angle exceeds the predetermined angle τ₁ in the clockwise direction. Here, the predetermined angle τ₁ in the clockwise direction may be set as the minimum angle required for the ego vehicle to make a right turn.

That is, for a right turn, it may be determined whether it exceeds the same angle size as the left turn but in the opposite direction, thereby determining whether the ego vehicle will make a right turn.

Further, the turn start distance may be determined by setting the same threshold distance τ₂ as in the left turn determination. However, it is not limited thereto; for a right turn, since the turn typically starts earlier than a left turn, a shorter distance than the predetermined distance τ₂ for the left turn determination may be set for the right turn determination.

If the turn angle of the ego vehicle exceeds the predetermined angle τ₁ in the clockwise direction and the turn start distance is less than the predetermined distance τ₂ (‘YES’ in S124), it may be determined that the ego vehicle will make a right turn at the intersection, and thus operation of the right turn signal is required (S125). Accordingly, in the turn signal operating step S130, the turn signal may be operated such that the right turn signal light is on (S132).

That is, if the road ahead is an intersection, the left turn determination condition and the right turn determination condition can be expressed as follows.

$$Turn Angle > {τ}_{1} AND Distance < {τ}_{2} : Left turn$$

$$Turn Angle < - {τ}_{1} AND Distance < {τ}_{2} : Right turn$$

Here, for the turn angle, the counter-clockwise direction is set as (+) value, and the clockwise direction is set as (−) value. For the right turn determination, the expression that the turn angle is smaller than −τ₁ means an angle greater than τ₁ in the clockwise direction.

Meanwhile, according to the embodiment of the present disclosure, road information indicating an intersection is determined first, and if the road is an intersection, the angle condition and distance condition described above are determined to determine whether it is a left turn or a right turn. This is to distinguish from cases where the ego vehicle is driving on a curved road. Since similar angle and distance conditions might be met even when driving on a curved road, in the embodiments of the present disclosure, the angle condition, the distance condition and the road information are simultaneously considered to determine situations where turn signal operation is required.

Meanwhile, if neither the turn angle and distance conditions regarding the left turn nor the turn angle and distance conditions regarding the right turn are met (‘NO’ in S124), the turn signal is not operated, and the process may return to step S110.

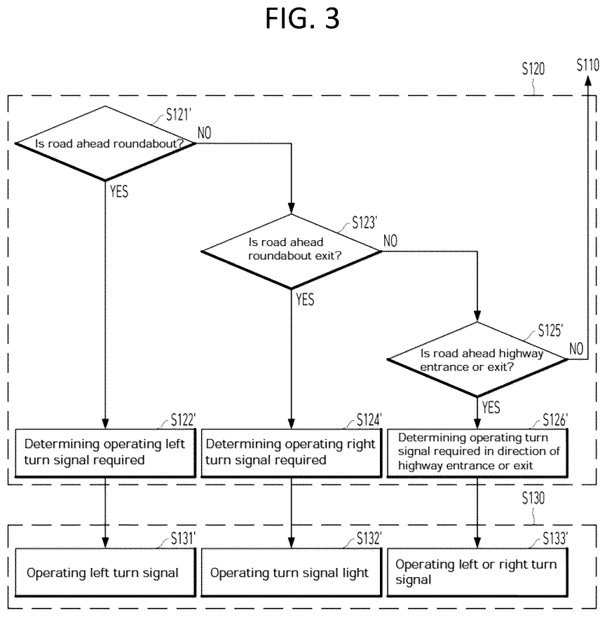

FIG. 3 is a control flowchart showing in more detail the step of determining whether turn signal operation is required and the turn signal operating step if the road ahead is a roundabout or other cases, in the method for operating the turn signal based on road information ahead according to the embodiment of the present disclosure.

Referring to FIG. 3, if the road information determined in the step of determining road information ahead indicates a roundabout (‘YES’ in S121′), it may be determined that operation of the left turn signal light is required (S122′).

This is because, according to traffic rules at roundabouts, it is necessary to enter with operating the left turn signal when entering a roundabout.

If it is determined based on the road information ahead that operation of the left turn signal is required, the turn signal may be operated such that the left turn signal operates (S131′) in the turn signal operating step S130.

Further, after the ego vehicle enters the roundabout, operation of the left turn signal may be controlled to the OFF state.

Meanwhile, while the ego vehicle is driving in the roundabout, based on the road information ahead and the driving path of the ego vehicle according to the navigation information, if it is determined that the ego vehicle will drive towards an exit lane of the roundabout (‘YES’ in S123′), it may be determined that operation of the right turn signal is required (S124′).

That is, the left turn signal may be operated before entering the roundabout to comply with traffic rules at roundabouts while driving at the roundabout, and the right turn signal may be operated before exiting to the exit lane.

After it is determined that operation of the right turn signal is required, the turn signal may be operated such that the right turn signal operates (S132′) in the turn signal operating step S130.

Further, roads other than intersections or roundabouts, for example, a highway entrance lane or exit lane, may also require turn signal operation according to embodiments of the present disclosure.

For example, if the road ahead is a highway entrance lane or a highway exit lane (‘YES’ in S125′), and the ego vehicle is predicted to drive towards the highway entrance lane or the highway exit lane according to the navigation route, it may be determined that turn signal operation is required in the direction where the highway entrance lane or the highway exit lane is located (S126′).

Accordingly, after it is determined that turn signal operation is required, the left or right turn signal may be operated in the direction of the highway entrance lane or the highway exit lane (S133′) in the turn signal operating step S130.

Meanwhile, the embodiments have illustrated intersections, roundabouts, or highway entrance/exit lanes (ramps), but the scope of the present disclosure is not limited thereto, and it can be applied to other road scenarios requiring turn signal operation.

FIG. 4 is a diagram for explaining a method for determining whether turn signal operation is required if the road ahead is an intersection and the ego vehicle makes a left turn along the driving path, in the method for operating the turn signal based on road information ahead according to the embodiment of the present disclosure.

Referring to FIG. 4, if the road ahead is an intersection (illustrated here is a 4-Way Intersection), and the ego vehicle makes a left turn along the driving path according to navigation information.

Information regarding the road type and Lane Link Geometry information may be obtained from the navigation information or HD map information of the ego vehicle.

The road information in FIG. 4 may indicate an intersection (LINKKIND=LINKKIND_Intersection). The Lane Link Geometry information may be points information for each part forming the curve for the ego vehicle making a left turn according to the navigation information. The angle of the tangent line at each position in this curve relative to the straight driving direction may be represented as a₁, a₂, a₃. By summing these angles, the turn angle can be calculated. Then, it may be determined whether this turn angle exceeds a predetermined angle τ₁ in the counter-clockwise direction.

Further, based on the predicted position where the ego vehicle starts turning, it may be determined whether the turn start distance is less than a predetermined distance τ₂.

Accordingly, as shown in FIG. 4, if the turn angle exceeds the predetermined angle τ₁ in the counter-clockwise direction and the turn start distance is less than the predetermined distance τ₂, it may be determined that the ego vehicle will make a left turn, and the left turn signal may be operated.

$$Turn Angle > {τ}_{1} AND Distance < {τ}_{2} : Left turn$$

FIG. 5 is a diagram for explaining a method for determining whether turn signal operation is required if the road ahead is an intersection and the ego vehicle makes a right turn along the driving path, in the method for operating the turn signal based on road information ahead according to the embodiment of the present disclosure.

Referring to FIG. 5, if the road ahead is an intersection (4-Way Intersection), and the ego vehicle makes a right turn along the driving path according to navigation information.

The road information in FIG. 5 may indicate an intersection (LINKKIND=LINKKIND_Intersection). Using the Lane Link Geometry obtained from the navigation information or HD map information of the ego vehicle, it may be determined whether the sum of the angles a₁, a₂ exceeds a predetermined angle τ₁ in the clockwise direction.

Accordingly, as shown in FIG. 5, if the turn angle exceeds the predetermined angle τ₁ in the clockwise direction and the turn start distance is less than the predetermined distance τ₂, it may be determined that the ego vehicle will make a right turn, and the right turn signal can be operated.

$$Turn Angle < - {τ}_{1} AND Distance < {τ}_{2} : Right turn$$

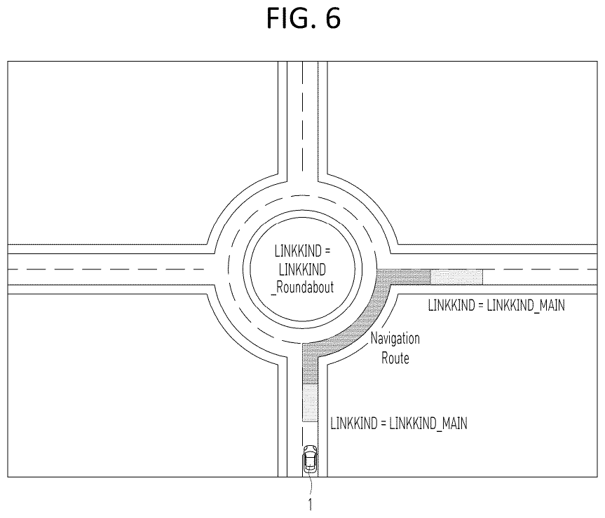

FIG. 6 is a diagram for explaining a method for determining whether turn signal operation is required if the road ahead is a roundabout, in the method for operating the turn signal based on road information ahead according to the embodiment of the present disclosure.

If the road ahead is a roundabout, the road information may be indicated as LINKKIND=LINKKIND_Roundabout. Meanwhile, the road before entering the roundabout may be a main road, and the corresponding road information may be LINKKIND=LINKKIND_MAIN.

If the ego vehicle is within a predetermined distance before entering the roundabout, it may be determined that operation of the left turn signal is required. Accordingly, the left turn signal may be controlled to operate.

Meanwhile, once the ego vehicle 1 enters the roundabout, the left turn signal may be controlled to the OFF state. If it is determined that the ego vehicle will exit to an exit lane while driving in the roundabout, the road (exit lane) after exiting the roundabout would be a main road, so the corresponding road information may be LINKKIND=LINKKIND_MAIN.

Based on the road information ahead, if it is determined that the ego vehicle 1 will exit to the exit lane from the roundabout, it may be determined that operation of the right turn signal is required, and accordingly, the right turn signal of the ego vehicle 1 may be controlled to operate.

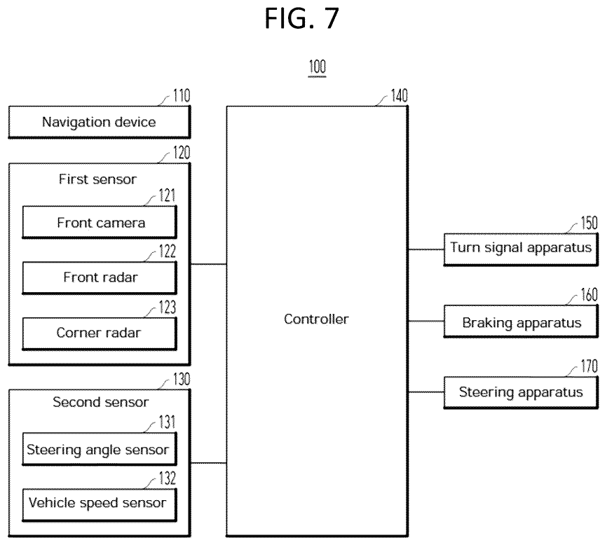

FIG. 7 is a control configuration diagram schematically showing the configuration of a system for operating a turn signal based on road information ahead according to embodiments of the present disclosure.

Referring to FIG. 7, the system for operating a turn signal based on road information ahead 100 according to an embodiment of the present disclosure may comprise: a navigation device 110 configured to provide road information ahead of the ego vehicle and the driving path of the ego vehicle; a controller 140 configured to control the operation of the turn signal of the ego vehicle based on the information provided by the navigation device 110; and a turn signal apparatus 150 configured to operate the turn signal of the ego vehicle.

The controller 140, based on the road information ahead and the driving path of the ego vehicle according to the navigation information, may determine whether turn signal operation is required, and control the turn signal apparatus 150 to operate the turn signal of the ego vehicle based on whether the operation is required.

The navigation device 110 may provide road information ahead of the ego vehicle and the driving path of the ego vehicle. Specifically, the navigation device 110 may provide position information of the ego vehicle using a GPS sensor, and provide information regarding road information ahead and the driving path (navigation route) of the ego vehicle using navigation map information.

Further, the system according to the embodiment may additionally comprise an HD Map (High-Definition Map), and the road information ahead of the ego vehicle may also be collected using information from the HD Map.

Further, the system for operating a turn signal light based on road information ahead 100 according to embodiments of the present disclosure may further comprise a first sensor 120 configured to detect the surroundings of the ego vehicle and a second sensor 130 configured to detect body information of the ego vehicle.

The first sensor 120 may include at least one of a front camera 121, a front radar 122, or a plurality of corner radars 123 installed at the ego vehicle. However, the sensors included in the first sensor 120 are not limited thereto, and may additionally include other types of sensors for detecting the surroundings of the vehicle, such as lidar sensors, ultrasonic sensors, etc.

The second sensor 130 may include at least one of a steering angle sensor 131 or a vehicle speed sensor 132. However, the sensors included in the second sensor 130 are not limited thereto, and may additionally include other types of sensors for detecting the body information of the ego vehicle, if applicable.

The controller 140, if the road ahead is an intersection, may determine the size of the turn angle of the ego vehicle according to the predicted driving path at the intersection based on the driving path according to the navigation information, and determine the turn start distance from the current position of the ego vehicle to the position where the ego vehicle starts turning.

Further, the controller 140 may control the turn signal apparatus 150 to operate the left turn signal by determining that the ego vehicle will make a left turn at the intersection, if the turn angle exceeds a predetermined angle in the counter-clockwise direction and the turn start distance is less than a predetermined distance.

Further, the controller 140 may control the turn signal apparatus 150 to operate the right turn signal by determining that the ego vehicle will make a right turn at the intersection, if the turn angle exceeds the predetermined angle in the clockwise direction and the turn start distance is less than the predetermined distance.

Further, after the ego vehicle enters the roundabout, the controller 140 may control the turn signal apparatus to operate the left turn signal to be the OFF state.

Next, while the ego vehicle is driving in the roundabout, if it is determined based on the road information ahead and the driving path according to the navigation information that the ego vehicle will drive towards an exit lane of the roundabout, the controller 140 may control the turn signal apparatus 150 to operate the right turn signal.

Meanwhile, in situations where the road ahead is not an intersection or roundabout, for example, if the ego vehicle is to drive into a highway entrance lane or a highway exit lane based on the road information ahead and the navigation route, the controller 140 may control the turn signal apparatus 150 to operate the left or right turn signal in the direction where the highway entrance lane or the highway exit lane is located.

Further, the system for operating a turn signal light based on road information ahead 100 according to embodiments of present disclosure may further include a braking apparatus 160 configured to control the longitudinal driving of the ego vehicle and a steering apparatus 170 configured to control the lateral driving of the ego vehicle.

Accordingly, when the ego vehicle is under autonomous driving control, the controller 140 may control at least one of the braking apparatus 160 or the steering apparatus 170 to drive the ego vehicle in the direction where the turn signal is operated.

Regarding the method for operating a turn signal based on road information ahead according to the embodiment of the present disclosure performed by the controller 140, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiment of the present disclosure as described above, it is possible to provide a method and system for operating a turn signal based on road information ahead that the turn signal can be operated in the correct direction at the appropriate time point in situations requiring turn signal operation, by utilizing road information ahead and the driving path according to navigation information.

Further, according to the method and system for operating a turn signal based on road information ahead according to the embodiment, during autonomous driving on urban roads, optimal turn signal operation control can be performed in various road driving scenarios.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
100: System for operating turn signal based on road information ahead
110: Navigation device
120: First sensor
121: Front camera
122: Front radar
123: Corner radar
130: Second sensor
131: Steering angle sensor
132: Vehicle speed sensor
140: Controller
150: Turn signal apparatus
160: Braking apparatus
170: Steering apparatus

1. A method for operating a turn signal based on road information ahead, comprising:
determining road information ahead based on navigation information;
determining whether operation of a turn signal is required based on the road information ahead and a driving path of an ego vehicle according to the navigation information; and
operating the turn signal of the ego vehicle based on whether the operation of the turn signal is required.

2. The method of claim 1, wherein if the road information ahead indicates an intersection in the determining of the road information, the determining of whether the operation of the turn signal is required further comprises:
determining a size of a turn angle of the ego vehicle according to a predicted driving path at the intersection based on the driving path of the ego vehicle according to the navigation information.

3. The method of claim 2, wherein the size of the turn angle of the ego vehicle is obtained by summing angles of tangent lines at respective positions of a curve comprising a plurality of points along a navigation route.

4. The method of claim 3, wherein the determining of whether the operation of the turn signal is required further comprises:
determining a turn start distance from a current position of the ego vehicle to a position where the ego vehicle starts turning.

5. The method of claim 4, further comprising:
determining that operation of a left turn signal is required by determining that the ego vehicle will make a left turn at the intersection, if the turn angle of the ego vehicle exceeds a predetermined angle in a counter-clockwise direction and the turn start distance is less than a predetermined distance.

6. The method of claim 5, further comprising:
determining that operation of a right turn signal is required by determining that the ego vehicle will make a right turn at the intersection, if the turn angle of the ego vehicle exceeds the predetermined angle in a clockwise direction and the turn start distance is less than the predetermined distance.

7. The method of claim 1, wherein if the road information ahead indicates a roundabout in the determining of the road information, the determining of whether the operation of the turn signal is required comprises:
determining that operation of a left turn signal is required at a predetermined distance before entering the roundabout.

8. The method of claim 7, further comprising:
after the ego vehicle enters the roundabout, controlling the left turn signal to an OFF state.

9. The method of claim 8, further comprising:
while the ego vehicle is driving in the roundabout, determining that operation of a right turn signal is required if it is determined that the ego vehicle will drive towards an exit lane of the roundabout, based on the road information ahead and the driving path of the ego vehicle according to the navigation information.

10. The method of claim 1, wherein if the road information ahead indicates a highway entrance lane or a highway exit lane in the determining of the road information, it is determined that operation of the turn signal is required in a direction of the highway entrance lane or the highway exit lane, based on the driving path of the ego vehicle according to the navigation information.

11. A system for operating a turn signal based on road information ahead, comprising:
a navigation device configured to provide road information ahead and a driving path of an ego vehicle;
a controller configured to control operation of a turn signal of the ego vehicle based on information provided by the navigation device; and
a turn signal apparatus configured to operate the turn signal of the ego vehicle,
wherein the controller is configured to:
determine whether operation of the turn signal is required based on the road information ahead and the driving path of the ego vehicle according to the navigation information; and
control the turn signal apparatus to operate the turn signal based on whether the operation of the turn signal is required.

12. The system of claim 11, wherein if the road information ahead indicates an intersection, the controller is configured to:
determine a size of a turn angle of the ego vehicle according to a predicted driving path at the intersection based on the driving path of the ego vehicle according to the navigation information; and
determine a turn start distance from a current position of the ego vehicle to a position where the ego vehicle starts turning.

13. The system of claim 12, wherein the controller is configured to control the turn signal apparatus to operate a left turn signal by determining that the ego vehicle will make a left turn at the intersection, if the turn angle of the ego vehicle exceeds a predetermined angle in a counter-clockwise direction and the turn start distance is less than a predetermined distance.

14. The system of claim 13, wherein the controller is configured to control the turn signal apparatus to operate a right turn signal by determining that the ego vehicle will make a right turn at the intersection, if the turn angle of the ego vehicle exceeds the predetermined angle in a clockwise direction and the turn start distance is less than the predetermined distance.

15. The system of claim 11, wherein if the road information ahead indicates a roundabout, the controller is configured to control the turn signal apparatus to operate a left turn signal by determining that operation of the left turn signal is required at a predetermined distance before entering the roundabout.

16. The system of claim 15, wherein the controller is configured to control the turn signal apparatus such that the left turn signal is in an OFF state after the ego vehicle enters the roundabout.

17. The system of claim 16, wherein the controller is configured to control the turn signal apparatus to operate a right turn signal if it is determined that the ego vehicle will drive towards an exit lane of the roundabout, based on the road information ahead and the driving path of the ego vehicle according to the navigation information while the ego vehicle is driving in the roundabout.

18. The system of claim 17, wherein if the road information ahead indicates a highway entrance lane or a highway exit lane, the controller is configured to control the turn signal apparatus to operate the left turn signal or the right turn signal if it is determined that the ego vehicle will drive in a direction of the highway entrance lane or the exit lane, based on the driving path of the ego vehicle according to the navigation information.

19. The system of claim 11, further comprising:
a first sensor configured to detect surroundings of the ego vehicle; and
a second sensor configured to detect body information of the ego vehicle,
wherein the first sensor comprises at least one of a front camera, a front radar, or a corner radar, and the second sensor comprises at least one of a steering angle sensor or a vehicle speed sensor.

20. A non-transitory computer-readable recording medium that records a program for executing a method for operating a turn signal based on road information ahead on a computer, the method comprising:
determining road information ahead based on navigation information;
determining whether operation of a turn signal is required based on the road information ahead and a driving path of an ego vehicle according to the navigation information; and
operating the turn signal of the ego vehicle based on whether the operation of the turn signal is required.
